(19) United States
(12) Patent Application Publication
(10) Pub. No.: US 2018/0206202 A1
(43) Pub. Date: Jul. 19, 2018

(54) METHODS AND SYSTEMS FOR SYNCHRONIZING ACCESS FOR DISTRIBUTED MIMO COMMUNICATIONS

(71) Applicant: QUALCOMM Incorporated, San Diego, CA (US)

(72) Inventors: Simone Merlin, San Diego, CA (US); George Cherian, San Diego, CA (US); Maarten Menzo Wentink, Nijmegen (NL); Alfred Asterjadhi, San Diego, CA (US); Yan Zhou, San Diego, CA (US); Abhishek Pramod Patil, San Diego, CA (US)

(21) Appl. No.: 15/842,754

(22) Filed: Dec. 14, 2017

Related U.S. Application Data
(60) Provisional application No. 62/447,300, filed on Jan. 17, 2017.

(51) Int. Cl. H04W 56/00; H04B 7/0413; H04W 74/08

(52) U.S. Cl. CPC H04W 56/001; H04W 84/12; H04W 74/0858; H04B 7/0413

(57) ABSTRACT

Methods and systems for coordinating simultaneous transmission by two or more access points over a single channel of a wireless medium are disclosed. In one aspect, a method includes determining, by an access point, a plurality of opportunities for initiating synchronized transmissions over the channel, and initiating by the first wireless device, a transmission at an opportunity of the plurality of opportunities.

### CROSS REFERENCE TO RELATED APPLICATION

This application claims the benefit of U.S. Provisional Application No. 62/447,300 titled “METHODS AND SYSTEMS FOR SYNCHRONIZING ACCESS FOR DISTRIBUTED MIMO COMMUNICATIONS,” filed Jan. 17, 2017. The content of this prior application is considered part of this application and is hereby incorporated by reference in its entirety.

### TECHNICAL FIELD

This application relates generally to wireless communication, and more specifically to systems and methods for performing synchronized access in distributed MIMO wireless communication.

### BACKGROUND

Wireless communications systems are widely deployed to provide various types of communication content such as voice, video, packet data, messaging, broadcast, and so on. Wi-Fi or WiFi (e.g., IEEE 802.11) is a technology that allows electronic devices to connect to a wireless local area network (WLAN). A WiFi network may include an access point (AP) that may communicate with one or more other electronic devices (e.g., computers, cellular phones, tablets, laptops, televisions, wireless devices, mobile devices, “smart” devices, etc.), which can be referred to as stations (STAs). The AP may be coupled to a network, such as the Internet, and may enable one or more STAs to communicate via the network or with other STAs coupled to the AP.

Many wireless networks utilize carrier-sense multiple access with collision detection (CSMA/CD) to share a wireless medium. With CSMA/CD, before transmission of data on the wireless medium, a device may listen to the medium to determine whether another transmission is in progress. If the medium is idle, the device may attempt a transmission. The device may also listen to the medium during its transmission, so as to detect whether the data was successfully transmitted, or if perhaps a collision with a transmission of another device occurred. When a collision is detected, the device may wait for a period of time and then re-attempt the transmission. The use of CSMA/CD allows for a single device to utilize a particular channel (such as a spatial or frequency division multiplexing channel) of a wireless network.

Users continue to demand greater and greater capacity from their wireless networks. For example, video streaming over wireless networks is becoming more common. Video teleconferencing may also place additional capacity demands on wireless networks. In order to satisfy the bandwidth and capacity requirements users require, improvements in the ability of a wireless medium to carry larger and larger amounts of data are needed.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

In certain embodiments, a method transmits data on a wireless network. The method comprises determining, by an access point, a plurality of opportunities for initiating synchronized transmissions of portions of distributed MIMO communications by a plurality of access points of the wireless network. The method further comprises initiating, by the first wireless device, a transmission of a portion of a distributed MIMO communication at an opportunity of the plurality of opportunities.

In certain embodiments, a method coordinates a distributed MIMO communication of a wireless network. The method comprises generating a message indicating a plurality of opportunities for initiating synchronized transmissions of portions of distributed MIMO communications by a plurality of access points of the wireless network. The method further comprises transmitting the message to the plurality of access points.

In certain embodiments, an apparatus for wireless communication comprises an electronic hardware processor configured to transmit data on a wireless network. The electronic hardware processor is configured to determine a plurality of opportunities for initiating synchronized transmissions of portions of distributed MIMO communications by a plurality of access points of the wireless network. The electronic hardware processor is further configured to initiate a transmission of a portion of a distributed MIMO communication at an opportunity of the plurality of opportunities.

In certain embodiments, an apparatus for wireless communication comprises an electronic hardware processor configured to coordinate a distributed MIMO communication of a wireless network. The electronic hardware processor is configured to generate a message indicating a plurality of opportunities for initiating synchronized transmissions of portions of distributed MIMO communications by a plurality of access points of the wireless network. The electronic hardware processor is further configured to transmit the message to the plurality of access points.

In certain embodiments, a non-transitory computer-readable medium comprises instructions that, when executed, perform a method of transmitting data on a wireless network. The method comprises determining, by an access point, a plurality of opportunities for initiating synchronized transmissions of portions of distributed MIMO communications by a plurality of access points of the wireless network. The method further comprises initiating, by the first wireless device, a transmission of a portion of a distributed MIMO communication at an opportunity of the plurality of opportunities.

In certain embodiments, a non-transitory computer-readable medium comprises instructions that, when executed, perform a method of coordinating a distributed MIMO communication of a wireless network. The method comprises generating a message indicating a plurality of opportunities for initiating synchronized transmissions of portions of distributed MIMO communications by a plurality of access points of the wireless network. The method further comprises transmitting the message to the plurality of access points.

### BRIEF DESCRIPTION OF THE DRAWINGS

FIG. 1 schematically illustrates an example wireless communication system in which aspects of the present disclosure may be employed.

FIG. 2 schematically illustrates an example wireless device that may be employed within the example wireless communication system of FIG. 1.

FIG. 3 schematically illustrates an example configuration of a distributed MIMO wireless communication system in accordance with certain embodiments described herein.

FIG. 4 schematically illustrates example communication options compatible with a distributed MIMO wireless communication system in accordance with certain embodiments described herein.

FIG. 5 schematically illustrates an example plurality of basic service sets (BSSs) of a distributed MIMO wireless communication system grouped into clusters in accordance with certain embodiments described herein.

FIG. 6 schematically illustrates an example scheme for providing synchronized access within a cluster in accordance with certain embodiments described herein.

FIG. 7 schematically illustrates another example scheme for providing synchronized access within a cluster in accordance with certain embodiments described herein.

FIG. 8 schematically illustrates another example scheme for providing synchronized access within a cluster in accordance with certain embodiments described herein.

FIG. 9 is a flow diagram of an example method of transmitting data on a wireless network in accordance with certain embodiments described herein.

FIG. 10 is a flow diagram of an example method 1000 of coordinating a distributed

MIMO communication in accordance with certain embodiments described herein.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently or combined with any other aspect of the disclosure. In addition, the scope is intended to cover such an apparatus or method which is practiced using other structure and functionality as set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The word “exemplary” is used herein to mean “serving as an example, instance, or illustration.” Any implementation described herein as “exemplary' is not necessarily to be construed as preferred or advantageous over other implementations. The following description is presented to enable any person skilled in the art to make and use the embodiments described herein. Details are set forth in the following description for purpose of explanation. It should be appreciated that one of ordinary skill in the art would realize that the embodiments may be practiced without the use of these specific details. In other instances, well known structures and processes are not elaborated in order not to obscure the description of the disclosed embodiments with unnecessary details. Thus, the present application is not intended to be limited by the implementations shown, but is to be accorded with the widest scope consistent with the principles and features disclosed herein.

Wireless access network technologies may include various types of wireless local area access networks (WLANs). A WLAN may be used to interconnect nearby devices together, employing widely used access networking protocols. The various aspects described herein may apply to any communication standard, such as Wi-Fi or, more generally, any member of the IEEE 802.11 family of wireless protocols.

In some implementations, a WLAN includes various devices which access the wireless access network. For example, there may be: access points (“APs”) and clients (also referred to as stations, or “STAs”). In general, an AP serves as a hub or a base station for the STAs in the WLAN. A STA may be a laptop computer, a personal digital assistant (PDA), a mobile phone, etc. In an example, an STA connects to an AP via a Wi-Fi (e.g., IEEE 802.11 protocol such as 802.11ah) compliant wireless link to obtain general connectivity to the Internet or to other wide area access networks. In some implementations an STA may also be used as an AP.

An access point (“AP”) may comprise, be implemented as, or known as a NodeB, Radio Access network Controller (“RNC”), eNodeB (“eNB”), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A station (“STA”) may also comprise, be implemented as, or known as a user terminal, an access terminal (“AT”), a subscriber station, a subscriber unit, a mobile station, a remote station, a remote terminal, a user agent, a user device, a user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, a Node-B (Base-station), or any other suitable device that is configured to communicate via a wireless medium.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). The cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS and LTE are described in documents from an organization named “3rd Generation Partnership Project” (3GPP). The cdma2000 is described in documents from an organization named “3rd Generation Partnership Project 2” (3GPP2). These various radio technologies and standards are known in the art.

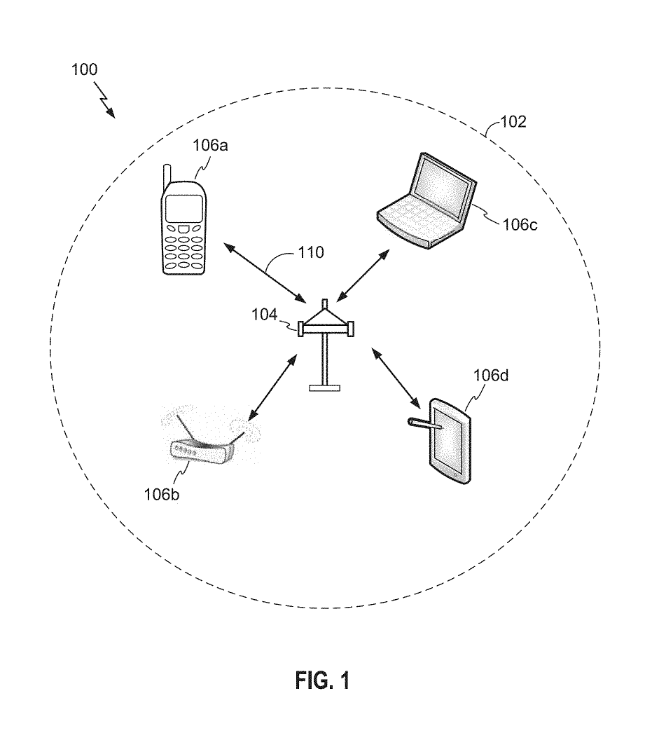

FIG. 1 is a diagram that illustrates a multiple-access multiple-input multiple-output (MIMO) system 100 with APs and STAs. For simplicity, only one AP 104 is shown in FIG. 1. As described above, the AP 104 communicates with the STAs 106a-d (also referred to herein collectively as “the STAs 106” or individually as “the STA 106”) and may also be referred to as a base station or using some other terminology. Also as described above, a STA 106 may be fixed or mobile and may also be referred to as a user terminal, a mobile station, a wireless device, or using some other terminology. The AP 104 may communicate with one or more STAs 106 at any given moment on the downlink or uplink. The downlink (i.e., forward link) is the communication link from the AP 104 to the STAs 106, and the uplink (i.e., reverse link) is the communication link from the STAs 106 to the AP 104. A STA 106 may also communicate peer-to-peer with another STA 106.

Portions of the following disclosure will describe STAs 106 capable of communicating via Spatial Division Multiple Access (SDMA). Thus, for such aspects, the AP 104 may be configured to communicate with both SDMA and non-SDMA STAs. This approach may conveniently allow older versions of STAs (e.g., “legacy” STAs) that do not support SDMA to remain deployed in an enterprise, extending their useful lifetime, while allowing newer SDMA STAs to be introduced as deemed appropriate.

The MIMO system 100 may employ multiple transmit and multiple receive antennas for data transmission on the downlink and uplink. The AP 104 is equipped with Nap antennas and represents the multiple-input (MI) for downlink transmissions and the multiple-output (MO) for uplink transmissions. A set of K selected STAs 106 collectively represents the multiple-output for downlink transmissions and the multiple-input for uplink transmissions. For pure SDMA, it is desired to have Nap≤K≤1 if the data symbol streams for the K STAs are not multiplexed in code, frequency or time by some means. K may be greater than Nap if the data symbol streams can be multiplexed using TDMA technique, different code channels with CDMA, disjoint sets of sub-bands with OFDM, and so on. Each selected STA may transmit user-specific data to and/or receive user-specific data from the AP. In general, each selected STA may be equipped with one or multiple antennas. The K selected STAs can have the same number of antennas, or one or more STAs may have a different number of antennas.

The MIMO system 100 may be a time division duplex (TDD) system or a frequency division duplex (FDD) system. For a TDD system, the downlink and uplink share the same frequency band. For an FDD system, the downlink and uplink use different frequency bands. The MIMO system 100 may also utilize a single carrier or multiple carriers for transmission. Each STA may be equipped with a single antenna (e.g., in order to keep costs down) or multiple antennas (e.g., where the additional cost can be supported). The MIMO system 100 may also be a TDMA system if the STAs 106 share the same frequency channel by dividing transmission/reception into different time slots, where each time slot may be assigned to a different STA 106.

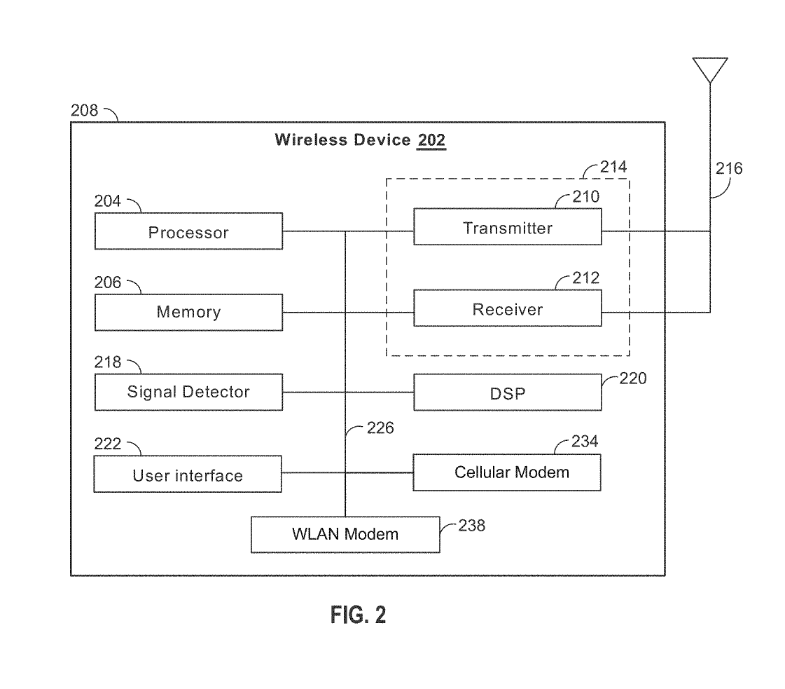

FIG. 2 illustrates various components that may be utilized in a wireless device 202 that may be employed within the wireless communication MIMO system 100. The wireless device 202 is an example of a device that may be configured to implement the various methods described herein. The wireless device 202 may implement an AP 104 or a STA 106.

The wireless device 202 may include an electronic hardware processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 may perform logical and arithmetic operations based on program instructions stored within the memory 206. The instructions in the memory 206 may be executable to implement the methods described herein.

The processor 204 may comprise or be a component of a processing system implemented with one or more electronic hardware processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. A single or a plurality of transceiver antennas 216 may be attached to the housing 208 and electrically coupled to the transceiver 214. The wireless device 202 may also include (not shown) multiple transmitters, multiple receivers, and multiple transceivers.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. In some aspects, the wireless device may also include one or more of a user interface component 222, cellular modem 234, and a wireless lan (WLAN) modem. The cellular modem 234 may provide for communication using cellular technologies, such as CDMA, GPRS, GSM, UTMS, or other cellular networking technology. The modem 238 may provide for communications using one or more WiFi technologies, such as any of the IEEE 802.11 protocol standards.

The various components of the wireless device 202 may be coupled together by a bus system, which may include a power bus, a control signal bus, and a status signal bus in addition to a data bus.

Certain aspects of the present disclosure support transmitting an uplink (UL) signal or a downlink (DL) signal between one or more STAs and an AP. In some embodiments, the signals may be transmitted in a multi-user MIMO (MU-MIMO) system. Alternatively, the signals may be transmitted in a multi-user FDMA (MU-FDMA) or similar FDMA system. In some aspects, these signals may be transmitted over one or more of the transmitter 210 and the modem 238.

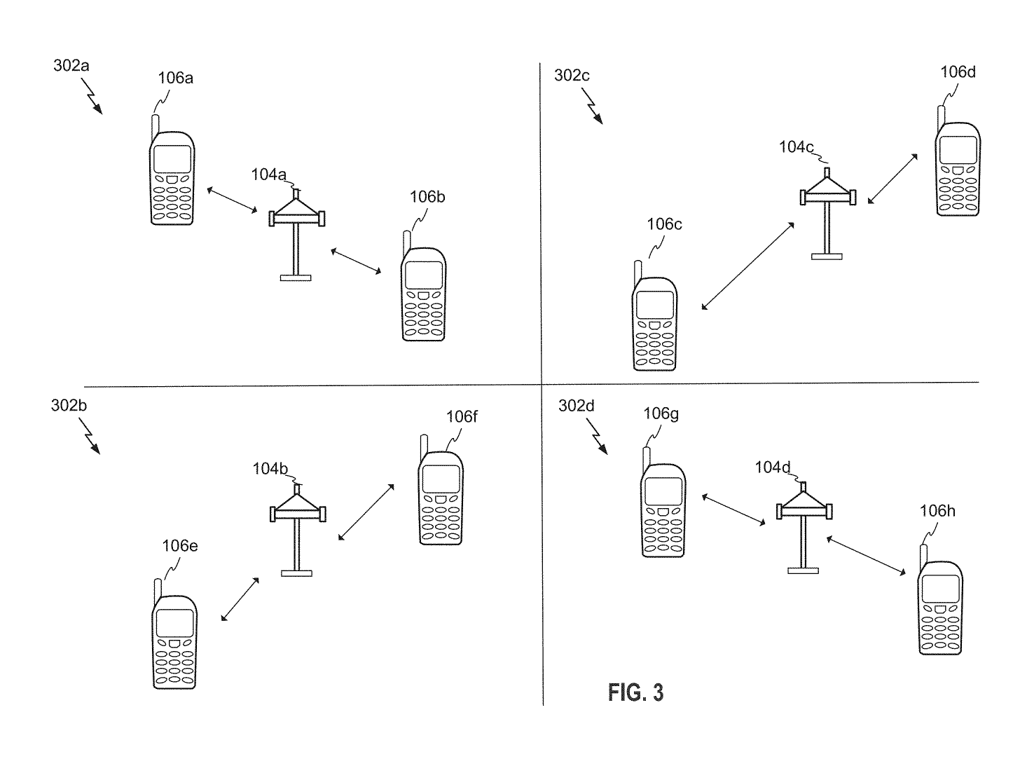

FIG. 3 shows four basic service sets (BSSs) 302a-d, each BSS including an access point 104a-d respectively. Each access point 104a-d is associated with at least two stations within its respective BSS 302a-d. AP 104a is associated with STA 106a-b. AP 104b is associated with STA 106c-d. AP 104c is associated with STA 106e-f. AP 104d is associated with STAs 106g-h. An AP that is associated with a STA may be referred to as a BSS AP for the STA throughout this disclosure. Similarly, an AP for which there is no association with a particular STA may be referred to as an OBSS AP for the STA throughout this disclosure. Associations between an AP and one or more stations provides for, in part, coordination of communication between devices within the basic service set (BSS) defined by the AP and its associated STAs. For example, devices within each BSS may exchange signals with each other. The signals may function to coordinate transmissions from the respective AP 104a-d and stations within the AP's BSS 302a-d.

The devices shown in FIG. 3, including the AP's 104a-d and STA 106a-h, also share a wireless medium. Sharing of the wireless medium is facilitated, in some aspects, via the use of carrier sense media access with collision detection (CSMA/CD). The disclosed embodiments may provide for a modified version of CSMA/CD that provides for an increase in an ability for the BSSs 302a-d to communicate simultaneously when compared to known systems.

The stations 106a-h within the BSSs 302a-d may have different abilities to receive transmissions from their associated AP based, at least in part, on their position relative to the other APs and/or stations outside their respective BSS (OBSS). For example, because the stations 106a, 106d, 106e, and 106h are positioned relatively far from OBSS APs, these stations may have an ability to receive transmissions from their BSS AP even with an OBSS AP or STA is transmitting. Stations having such receive characteristics may be referred to as Reuse STAs throughout this disclosure.

In contrast, STAs 106b, 106c, 106f, and 106g are illustrated in positions that are relatively close to an OBSS AP. Thus, these stations may have less ability to receive transmissions from their BSS AP during transmissions from OBSS AP's and/or OBSS STAs. Stations having such receive characteristics may be referred to as non-reuse or edge STAs throughout this disclosure. In some aspects, the disclosed methods and systems may provide for an improved ability for the non-reuse STAs to communicate concurrently while other OBSS devices are also communicating on the wireless medium.

In at least some of the disclosed aspects, two or more of the APs 104a-d may negotiate to form a cluster of access points. In other aspects, cluster configurations may be defined via manual configuration. For example, each AP may maintain configuration parameters indicating whether the AP is part of one or more cluster, and if so, a cluster identifier for the cluster. In some aspects, the configuration may also indicate whether the AP is a cluster controller for the cluster. In some of the embodiment disclosed herein, a cluster controller may take on functions that differ from APs that are part of the cluster but are not a cluster controller. Thus, in some aspects, two or more of APs 104a-d may be included in the same cluster. STAs associated with those access points may also be considered to be included in or part of the cluster of their associated AP. Therefore, in some aspects the STAs a-h illustrated above may be part of the same cluster.

The cluster of access points may coordinate transmissions between themselves and their associated APs. In some aspects, the cluster may be identified via a cluster identifier that uniquely identifies the group of access points comprising the cluster. In some aspects, during association of a station with any of the APs in a cluster, the cluster identifier is transmitted to the station during association, for example, in an association response message. The station may then utilize the cluster identifier to coordinate communications within the cluster. For example, one or more messages transmitted over the wireless network may include the cluster identifier, which a receiving STA may use to determine whether the message is addressed to it or not.

Embodiments that cluster of access points may also utilize various methods to identify STAs within the cluster. For example, as known methods of generating association identifiers (AIDs) may not provide uniqueness across access points, in some aspects, media access control (MAC) addresses may be utilized to identify stations where appropriate. For example, known messages including user info fields that utilize association identifiers to identify stations may be modified to contain data derived from station MAC addresses in the disclosed embodiments. Alternatively, methods of generating association identifiers may be modified to ensure uniqueness within a cluster of access points. For example, a portion of the association identifier may uniquely identify an access point within the cluster. Stations associated with that access point would be assigned association identifiers including the unique identification. This provides unique association identifiers across access points within a cluster. In some other aspects, an association identifier within a cluster may include the cluster identifier. This may provide for uniqueness across clusters to facilitate future cross-cluster coordination of communication.

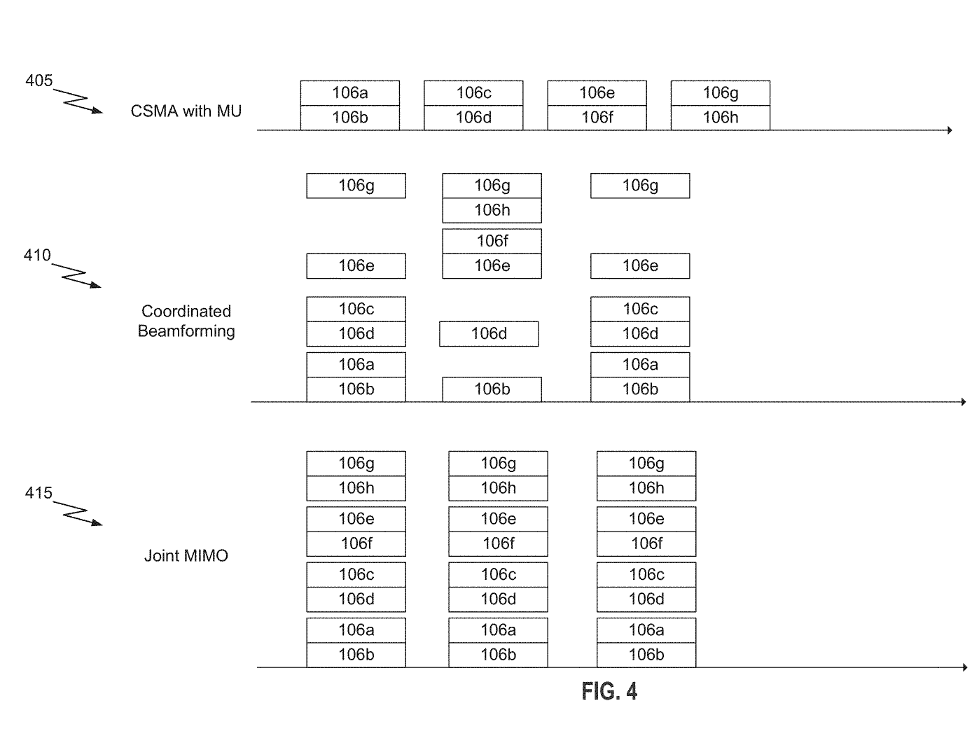

FIG. 4 shows three exemplary approaches to arbitrating the wireless medium with the communications system 300 of FIG. 3. Approach 405 utilizes carrier sense media access (CSMA) to perform single BSS multi-user transmissions. For example, each of transmissions 420a-d may be performed by the BSSs 302a-d of FIG. 3 respectively. The use of traditional CSMA in approach 405 causes the medium to be utilized by only one BSS at any point in time.

Approach 410 utilizes coordinated beamforming. With the coordinated beamforming approach 410, the APs 104a-d may coordinate transmissions between their respective BSSs. In some aspects, this coordination may be performed over the wireless medium, or in some aspects, over a back-haul network. In these aspects, the coordination traffic over the backhaul network provided for improved utilization of the wireless medium.

With this approach, reuse STAs for different BSSs may be scheduled to transmit or receive data concurrently. For example, a relative strength of a communication channel between STA 106a and AP 104a may allow these two devices to exchange data simultaneously with communication with OBSS devices, such as, for example, AP 104b and STA 106d. In addition, approach 410 provides for non-reuse STAs may be scheduled to transmit concurrently with OBSS devices. For example, STA 106b, which is within BSS 302, may be scheduled to communicate simultaneous with communication between AP 104d and STA 106h of BSS 302d. Such simultaneous communication between a non-reuse STA (such as STA 106b) and, for example, AP 104d may be facilitated by scheduling AP 104d to transmit a signal to STA 106b simultaneous with AP 104d's transmission to STA 106h. For example, AP 104d may transmit a null signal for dominant interfering signals to STA 106b. Thus, while transmitting a first signal to STA 106h, AP 104d may simultaneously transmit a signal nulling the first signal to STA 106b. Such simultaneous transmission by the AP 104d may be provided by selecting individual antenna(s) of a plurality of antennas provided by AP 104d for each of the transmissions.

Approach 415 shows an exemplary joint multi-user communication or a distributed MIMO communication across access points 104a-d within the BSSs 302a-d. With this joint MIMO approach 415, a cluster of APs (such as APs 104a-d) may service N 1-SS STAs simultaneously, where N is ˜¾ of a total number of antennas across all APs within the cluster. Distributed MIMO communications may coordinate a collection of antennas across the multiple APs within a cluster to transmit to stations within the cluster. Thus, while traditional MIMO methods allocate transmit antennas within a single BSS to stations within the BSS, distributed MIMO provides for allocation of transmit antennas outside a BSS to facilitate communications with stations within the BSS.

In a distributed MIMO communication, a station in one BSS may communicate with one or more access points in another, different BSS. Thus, for example, station 106a of BSS 302a of FIG. 3 may communication with access point 104d, which is in BSS 302d. This communication may occur simultaneously with communication between STA 106a and AP 104a, the BSS AP of the STA 106a. In some aspects of an uplink distributed MIMO communication, the STA 106a may conduct one or more uplink communications to AP 104a simultaneously with AP 104d. Alternatively, a downlink distributed MIMO communication may include AP 104a transmitting data to STA 106a simultaneously with a transmission from AP 104d to STA 106a.

Thus, one or more of the distributed embodiments may utilize MIMO in the form of Cooperative Multipoint (CoMP, also referred to as e.g. Network MIMO (N-MIMO), Distributed MIMO (D-MIMO), or Cooperative MIMO (Co-MIMO), etc.) transmission, in which multiple access points maintaining multiple corresponding basic service sets, can conduct respective cooperative or joint communications with one or more STAs 106. CoMP communication between STAs and APs can utilize for example, a joint processing scheme, in which an access point associated with a station (a BSS AP) and an access point that is not associated with a station (a OBSS AP) cooperate to engage in transmitting downlink data to the STA and/or jointly receiving uplink data from the STA. Additionally or alternatively, CoMP communication between an STA and multiple access points can utilize coordinated beamforming, in which a BSS AP and an OBSS AP can cooperate such that an OBSS AP forms a spatial beam for transmission away from the BSS AP and, in some aspects, at least a portion of its associated stations, thereby enabling the BSS AP to communicate with one or more of its associated stations with reduced interference.

To facilitate the coordinated beamforming approach 410 or the joint MIMO approach 415, an understanding of channel conditional between an access point and OBSS devices may provide for greater wireless communication efficiency.

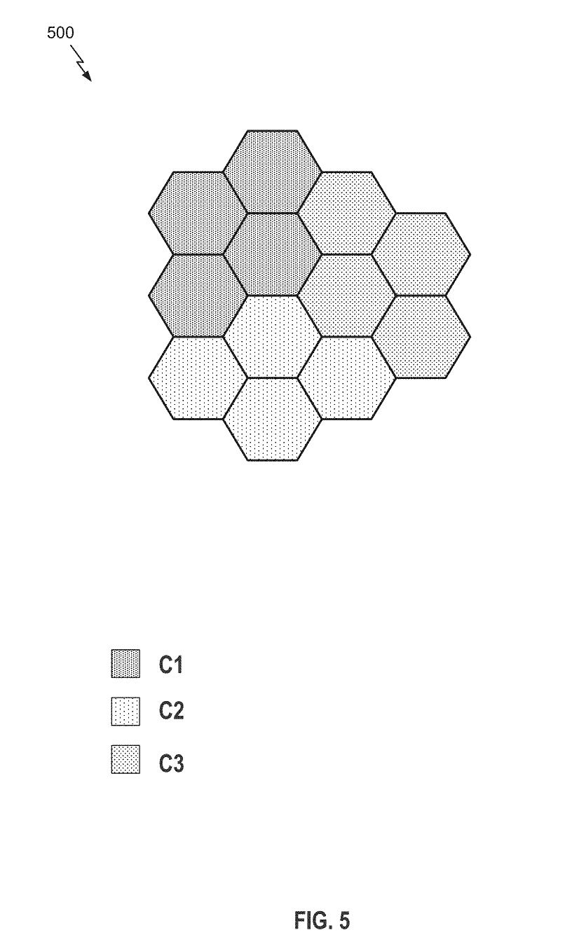

FIG. 5 schematically illustrates a plurality of basic service sets (BSSs) 500 of an exemplary distributed MIMO wireless communication system. Each hexagon of FIG. 5 represents an access point and associated stations, collectively referred to as a basic service set (BSS). The individual BSSs are grouped into clusters in accordance with certain embodiments described herein. In the example schematically illustrated by FIG. 5, a first cluster (C1) comprises four BSSs, a second cluster (C2) comprises four BSSs, and a third cluster (C3) comprises four BSSs. In certain other embodiments, a cluster can comprise 2, 3, 4, 5, or any numbers of BSSs and a wireless communication system can comprise one or more clusters (e.g., 2, 3, 4, 5 or other numbers of clusters).

In certain embodiments, to perform distributed MIMO communications, devices within two or more BSSs of a cluster may transmit over a single channel simultaneously (e.g., transmit data from a plurality of access points of the BSS simultaneously via the single channel, or transmit data from a plurality of stations in different BSSs simultaneously to a single AP). In some aspects, a centralized scheduler (not shown) may coordinate transmissions across the clusters C1-C3. For example, coordination may include selecting which devices will transmit simultaneously from multiple BSSs to perform a joint MIMO communication.

Under European Telecommunications Standard Institute (ETSI) regulations, wireless communication systems are generally required to utilize clear channel assessment (CCA) or listen-before-talk (LBT) before allowing access to the wireless network. Generally, two different access modes are allowed in such wireless communication systems: “frame-based” access mode and “load-based” access mode. To utilize coordinated access in an unlicensed spectrum, it is generally desirable for a device on the wireless network to use a safe or allowed mechanism for ignoring same-network deferral while honoring LBT toward other devices on the wireless network. A similar issue arises with licensed assisted access (LAA) systems, which are bound to a fixed frame structure. However, in wireless communication systems which are not bound to a fixed frame structure (e.g., WiFi), a more flexible and/or efficient solution may be used. Certain embodiments described herein advantageously provide a way to enable reuse (e.g., stations able to serve simultaneously without having to be nulled) by synchronizing the physical layer convergence procedure (PLCP) protocol data unit (PPDU) start time, which may be seen as a forced collision. In certain such embodiments, the timing scheme is configured so that energy detect (ED) or power detect (PD) operations do not trigger within the same wireless network at the start of a frame (e.g., having a standard that defines requirements for CCA timing and synchronization).

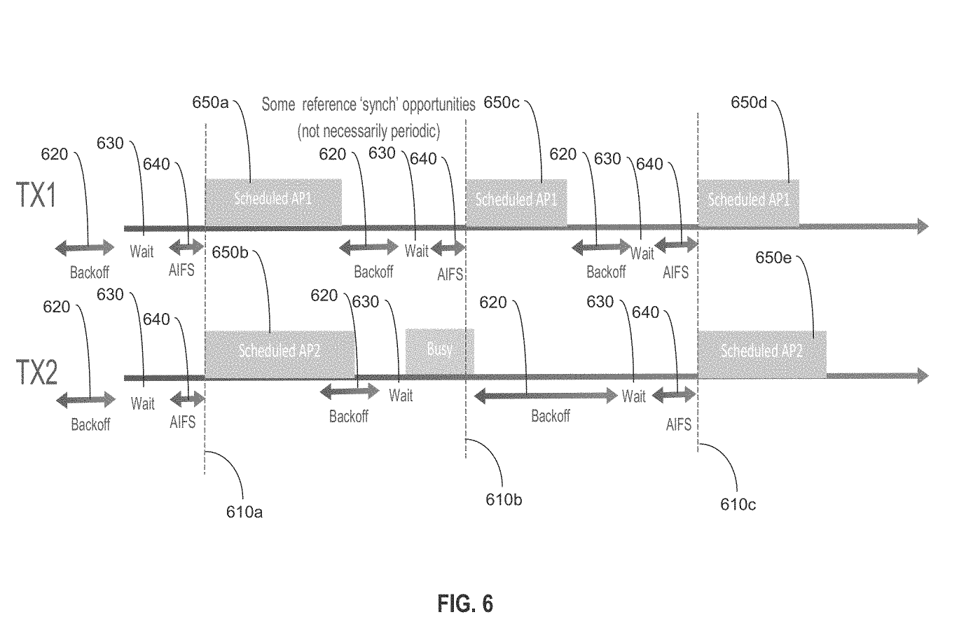

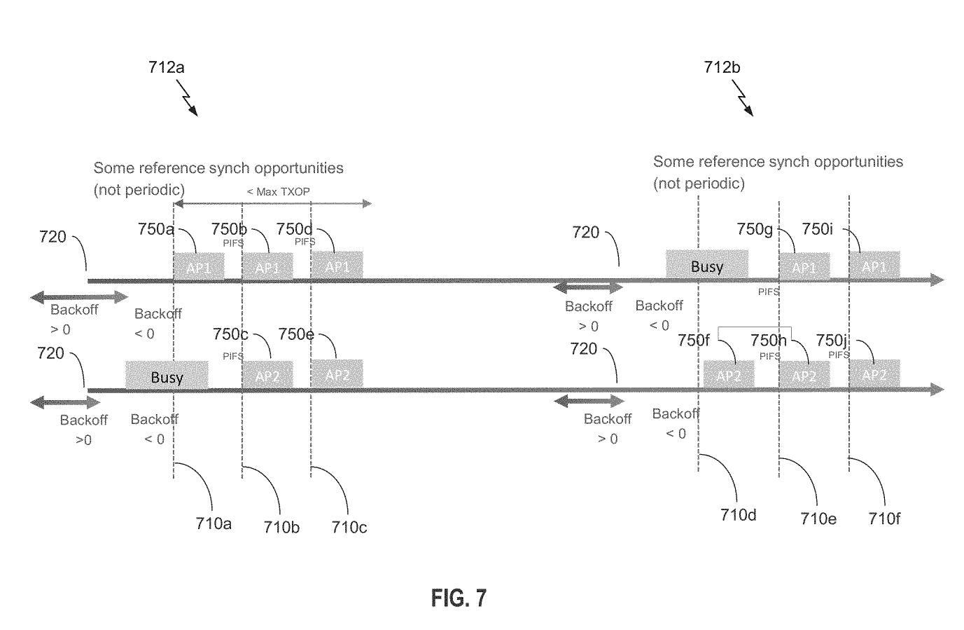

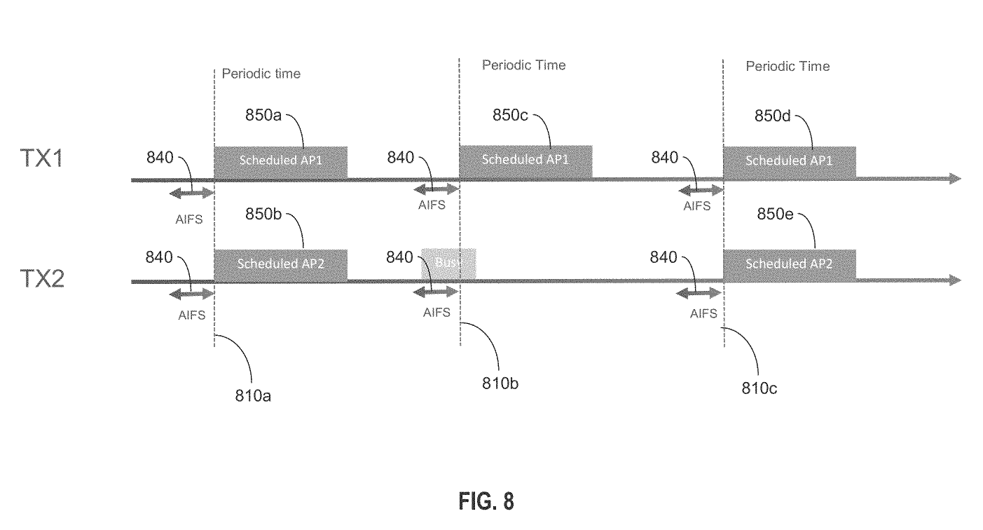

Each of FIGS. 6-8 schematically illustrates a corresponding example scheme for providing synchronized access within a cluster (e.g., a wireless network or a portion of a wireless network) that achieves medium reuse in accordance with certain embodiments described herein. The example schemes schematically illustrated by FIGS. 6 and 7 can each be considered as options of a back-off based mode of synchronized enhanced distributed channel access (EDCA), and the example scheme schematically illustrated by FIG. 8 can be considered to be a fully scheduled mode.

In the example schemes schematically illustrated by FIGS. 6-8, access points within a cluster synchronize their transmissions within a distributed MIMO communication via a plurality of transmission opportunities. These opportunities are illustrated as opportunities 610a-c, 710a-f, 810a-c (e.g., reference synchronization opportunities) in each of FIGS. 6, 7, and 8 respectively. The plurality of opportunities 610a-c, 710a-f, 810a-c can be periodic or can be not periodic in nature.

In some aspects, a central controller, or a central access point, may determine the timing parameters for the transmission opportunities and transmit this information to access points participating in a distributed MIMO communication. , and can be determined by an access point of the cluster of the wireless network. For example, multiple access points (e.g., a first access point and a second access point) of the cluster can each receive a signal indicative of the plurality of opportunities. For example, one of the first wireless devices of the cluster of the wireless network (e.g., the first access point TX1 or the second access point TX2) can generate the signal and can transmit the signal to the other access points of the cluster of the wireless network. For another example, the signal is transmitted from another component of the wireless network (not shown) to each of the first wireless devices (e.g., to both TX1 and TX2) of the cluster of the wireless network.

In certain other embodiments, the determination of the synchronized transmission opportunities results from a peer to peer negotiation between access points participating in the communication. For example, in some aspects, access points participating in a distributed MIMO communication may transmit network messages indicative of local clock signals, and in some aspects, information indicative of a difference between the local clock signal and a clock signal of another access point received via a network message. In some aspects, the first wireless devices may receive a signal (e.g., a beacon signal) indicating this timing information. As described herein, the signal may also be referred to as a “synchronization signal,” in some embodiments. In an aspect, a beacon signal may be a backhaul signal. In an aspect, a beacon signal may comprise all, or a portion of, a beacon frame (e.g., an 802.11 Beacon frame). In certain embodiments, such signals (e.g., the above-described backhaul signals, beacon frames, etc.) may be decoded by each of the first wireless devices which receives the signals to determine a time for the synchronized distributed MIMO communication to occur. In some aspects, a target opportunity time information may be indicated in the beacon frame. Furthermore, any one or more of the plurality of opportunities 610a-c, 710a-f, 810a-c may be determined based on the target opportunity time. In some aspects, any beacon signal as described herein (e.g., a backhaul signal) may be received via a hardwired connection.

FIG. 6 describes a synchronization method that is based on individual periods of time in which a distributed MIMO communication may occur. The individual periods of time are synchronized across access points performing the distributed MIMO communication. As schematically illustrated by FIG. 6, each access point (e.g., TX1 and TX2) performs a back-off procedure 620 on the single channel prior to an opportunity 610a-c. Once the back-off procedure 620 is completed by an access point, the first wireless device may wait for a wait time 630 between the successful completion of the back-off procedure and an arbitration inter-frame spacing (AIFS) 640 before the opportunity 610a-c. Synchronization between the first wireless devices may define multiple opportunities which are used to align the data transmissions of access points that have completed their back-off procedures. In certain embodiments, “random” back-off counter values may be assigned to each of the first wireless devices (e.g., different back-off counter values to multiple access points; same back-off counter values to multiple access points). In certain embodiments, the initiation of the back-off procedures may be aligned between the first wireless devices participating in the distributed MIMO communication such that the back-off countdowns of the various access points are in synch with one another. In certain embodiments, idle time on the wireless medium between completion of the back-off procedure and the AIFS 640 prior to an opportunity (e.g. wait time 630) may be filled by an access point transmitting dummy data (e.g., preambles; data not to be acted upon by a receiving device) in response to the successful completion of the back-off procedure to fill the time between the successful completion of the back-off procedure 620 and the AIFS 640 before the opportunity 610a-c (e.g., to protect or reserve the single channel).

As schematically illustrated by FIG. 6, at the first opportunity 610a (leftmost dashed vertical line of FIG. 6), after each of TX1 and TX2 has performed its respective back-off procedure 620, wait time 630, and AIFS 640, TX1 checks whether its carrier sense (CS) state is busy and TX2 checks whether its CS state is busy. Since neither CS state is busy, both TX1 and TX2 transmit data 650a-b at this opportunity 610a. At the second opportunity 610b (middle dashed vertical line of FIG. 6), after each of TX1 and TX2 has again performed its respective back-off procedure 620, wait time 630, and AIFS 640, TX1 checks whether its CS state is busy and TX2 checks whether its CS state is busy. Since the CS state of TX1 is not busy, TX1 transmits data 650c at this opportunity 610b, but since the CS state of TX2 is busy, TX2 does not transmit data at this opportunity 610b. At the third opportunity 610c (rightmost dashed vertical line of FIG. 6), after each of TX1 and TX2 has again performed its respective back-off procedure 620, wait time 630, and AIFS 640, TX1 checks whether its CS state is busy and TX2 checks whether its CS state is busy. Since neither CS state is busy, both TX1 and TX2 transmit data 650d-e at this opportunity 610c.

The synchronization method illustrated in FIG. 7 differs from that of FIG. 6 in that each synchronized transmission opportunity may be divided into multiple portions. Thus, as schematically illustrated by FIG. 7, the plurality of opportunities 710a-f comprises two or more opportunities within a transmission opportunity (TXOP) 712a-b. For example, a transmission opportunity (TXOP) 712a-b can be divided into multiple opportunities for a sequence of AIFS-separated data transmissions. By defining multiple opportunities within a TXOP 712a-b, certain such embodiments can allow an access point to initiate a transmission within the TXOP 712a-b at a time different than the very beginning of the transmission opportunity (e.g., at a time after the TXOP 712a-b begins but before the TXOP 712a-b ends). Thus, if the first wireless device senses that the wireless medium is busy at the beginning of a transmission opportunity, it may not need to wait until an entirely new transmission opportunity occurs, but may be able to initiate a transmission at an intermediate point within the transmission opportunity. This solution, when compared to that of FIG. 6, illustrates a tradeoff between media access control (MAC) efficiency and reuse opportunities. In certain embodiments, waits by the first wireless device can comprise transmitting dummy data (e.g., preambles; data not to be acted upon by the first wireless devices) to fill a portion of the time before the opportunity (e.g., to protect or reserve the single channel).

As schematically illustrated by FIG. 7, a TXOP 712a has three opportunities 710a-c (three leftmost dashed vertical lines of FIG. 7) within a time period less than the maximum time period of this TXOP 712a. After each of TX1 and TX2 has performed its respective back-off procedure 720, at the first opportunity 710a of the three opportunities 710a-c of this TXOP 712a, TX1 checks whether its CS state is busy and TX2 checks whether its CS state is busy. Since the CS state of TX1 is not busy, TX1 transmits data 750a at this opportunity 710a, but since the CS state of TX2 is busy, TX2 does not transmit data at this opportunity 710a. The second opportunity 710b of this TXOP 712a occurs after each of TX1 and TX2 waits for a point coordination function (PCF) interframe spacing (PIFS), and at this opportunity 710b each of TX1 and TX2 again checks whether its respective CS states are busy. Since neither CS state is busy, both TX1 and TX2 transmit data 750b-c at this opportunity 710b. The third opportunity 710c of this TXOP 712a occurs after each of TX1 and TX2 waits for a PIFS, and at this opportunity 710c each of TX1 and TX2 again checks whether its respective CS states are busy. Since neither CS state is busy, both TX1 and TX2 transmit data 750d-e at this opportunity 710c.

A subsequent TXOP 712b also has three opportunities 710d-f (three rightmost dashed vertical lines of FIG. 7). After each of TX1 and TX2 has performed its respective back-off procedures 720, at the first opportunity 710d of the three opportunities 710d-f of this TXOP 712b, TX1 checks whether its CS state is busy and TX2 checks whether its CS state is busy. Since the CS state of TX1 is busy, TX1 does not transmit data at this opportunity 710d, but since the CS state of TX2 is not busy, TX2 does transmit data 750f at this opportunity 710d. The second opportunity 710e of this TXOP 712b occurs after each of TX1 and TX2 waits for a PIFS, and at this opportunity 710e each of TX1 and TX2 again checks whether its respective CS states are busy. Since neither CS state is busy, each of TX1 and TX2 transmits data 750g-h at this opportunity 710e. The third opportunity 710f of this TXOP 712b occurs after each of TX1 and TX2 waits for a PIFS, and at this opportunity 710f each of TX1 and TX2 again checks whether its respective CS states are busy. Since neither CS state is busy, each of TX1 and TX2 transmits data 750i-j at this opportunity 712b.

The example scheme schematically illustrated by FIG. 8 is based on a “frame based equipment” operation as allowed by ETSI. In certain embodiments, the data transmissions can be allowed to start at periodic coordinated times (e.g., only at frame periods to be declared and fixed to be greater than or equal to 200 milliseconds). In certain embodiments, the example scheme schematically illustrated by FIG. 8 is not used with WiFi, since certain such embodiments may have low access priority (e.g., if channel is busy at the frame start, the TXOP is lost) and may not be flexible.

As schematically illustrated by FIG. 8, the plurality of opportunities 810a-c are periodic (e.g., each opportunity is separated in time from the preceding opportunity by a constant time period). At the first opportunity 810a (leftmost dashed vertical line of FIG. 8), after each of TX1 and TX2 has waited their respective AIFS 840, TX1 checks whether its CS state is busy (e.g., ED is done right before transmissions) and TX2 checks whether its CS state is busy. Since neither CS state is busy, both TX1 and TX2 transmit data 850a-b at this opportunity 810a. At the second opportunity 810b (middle dashed vertical line of FIG. 8), after each of TX1 and TX2 has again waited its respective AIFS 840, TX1 checks whether its CS state is busy and TX2 checks whether its CS state is busy. Since the CS state of TX1 is not busy, TX1 transmits data 850c at this opportunity 810b, but since the CS state of TX2 is busy, TX2 does not transmit data at this opportunity 810b. At the third opportunity 810c (rightmost dashed vertical line of FIG. 8), after each of TX1 and TX2 has again waited its respective AIFS 840, TX1 checks whether its CS state is busy and TX2 checks whether its CS state is busy. Since neither CS state is busy, both TX1 and TX2 transmit data 850d-e at this opportunity 810c.

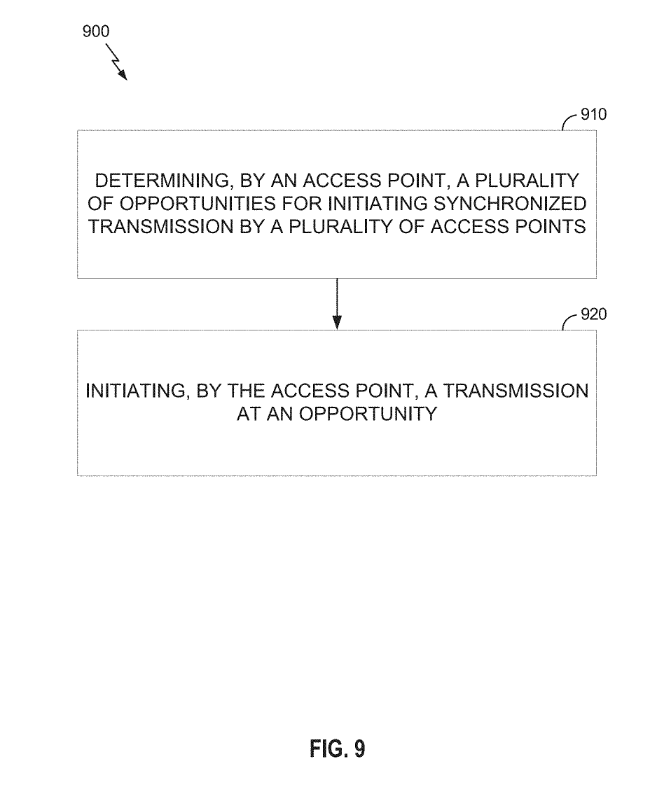

FIG. 9 is a flow diagram of an example method 900 of transmitting data on a wireless network in accordance with certain embodiments described herein. In some aspects, the method 900 discussed below with respect to FIG. 9 may be performed by the wireless device 202. For example, in some aspects, instructions stored in the memory 206 may configure the processor 204 to perform one or more of the functions discussed below with respect to FIG. 9.

Method 900 discussed below provides an exemplary method to coordinate simultaneous transmissions of two or more access points at the same time over a single channel of a wireless medium. By transmitting simultaneously, throughput of a wireless medium may be increased, due to increased parallelism between the two access points that may not occur with prior methods. To facilitate the simultaneous transmissions, the signals transmitted by each of the first wireless devices may be shaped to form a combined signal that may be properly received by the intended receiving devices. Thus, it can be beneficial to align these simultaneous transmissions such that the combined signal is formed in a beneficial manner

In a block 910, the method 900 comprises determining, by an access point, a plurality of opportunities for initiating synchronized transmissions of portions of distributed MIMO communications by a plurality of access points of the wireless network. In various examples, the plurality of opportunities can be determined per access category, and/or can be either periodic or non-periodic. In a block 920, the method 900 further comprises initiating, by the first wireless device, a transmission of a portion of a distributed MIMO communication at an opportunity of the plurality of opportunities.

In some aspects, the method 900 further comprises receiving, by the first wireless device, a signal indicative of the plurality of opportunities. In certain aspects, the signal may be a beacon signal, a backhaul signal, etc., as described above. The signal may comprise a beacon frame. Determining the plurality of opportunities may be based on the beacon frame. The beacon frame of some aspects may be received by the first wireless device from a second access point. In some aspects, the method 900 further comprises decoding the beacon frame to determine a target opportunity time indicated in the signal, and determining the plurality of opportunities may be based on the target opportunity time.

In some aspects, the method 900 further comprises performing a back-off procedure before the opportunity, and initiating the transmission in response to successful completion of the back-off procedure before the opportunity. In certain such aspects, the method 900 further comprises transmitting dummy data in response to the successful completion of the back-off procedure, with the dummy data transmitted for a time between the successful completion of the back-off procedure and an arbitration interframe space (AIFS) before the opportunity. The method 900 can further comprise initiating the transmission in response to the successful completion of the back-off procedure occurring at least an arbitration interframe (AIFS) space before the opportunity. In some aspects, the method 900 further comprises receiving, by the first wireless device, a network message indicating a back-off counter value, wherein performing the back-off procedure is based on the received back-off counter value. In some aspects, the method 900 further comprises receiving, by the first wireless device, a network message indicating a back-off start time, wherein performing the back-off procedure comprises initiating the back-off procedure at the indicated back-off start time.

In some aspects, the method 900 further comprises using the first wireless device at the opportunity of the plurality of opportunities to check whether a carrier sense (CS) state of the first wireless device is busy, and using the first wireless device to transmit data in response, at least in part, to the CS state being not busy. In certain such aspects, the first wireless device does not transmit data in response, at least in part, to the CS state being busy.

In some aspects, the plurality of opportunities comprises two or more opportunities within a transmission opportunity (TXOP). In certain such aspects, the method 900 can further comprise initiating a first opportunity of the two or more opportunities in response to a successful completion of a back-off procedure before the first opportunity of the two or more opportunities. In certain such aspects, the method 900 can further comprise initiating a second opportunity of the two or more opportunities without performing an additional back-off procedure. In some aspects, the method 900 further comprises fragmenting the transmission into at least two separate transmissions, a first transmission occurring from a beginning of a first opportunity of the two or more opportunities to an end time before a second opportunity of the two or more opportunities, and a second transmission occurring from a beginning of the second opportunity. In certain such aspects, the end time is at least a PCF Interframe Space (PIFS) before the beginning of the second opportunity.

In some aspects, the method 900 further comprises determining whether a wireless medium of the first wireless device is idle for an arbitration interframe (AIFS) space before the opportunity, wherein initiating the transmission is in response to the wireless medium being idle.

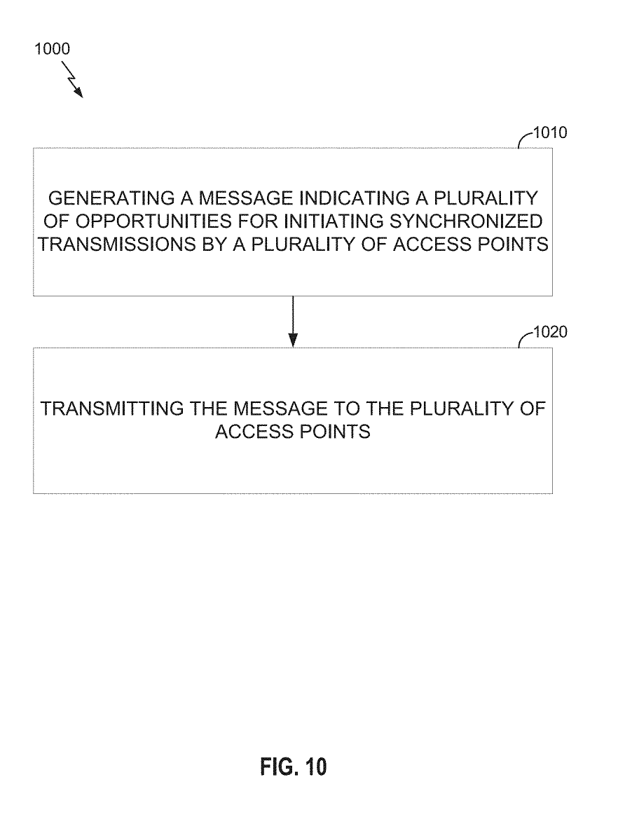

FIG. 10 is a flow diagram of an example method 1000 of coordinating a distributed MIMO communication in accordance with certain embodiments described herein. In some aspects, the method 1000 discussed below with respect to FIG. 10 may be performed by a system controller (e.g., the wireless device 202). For example, in some aspects, instructions stored in the memory 206 may configure the processor 204 to perform one or more of the functions discussed below with respect to FIG. 10.

In a block 1010, the method 1000 comprises generating a message indicating a plurality of opportunities for initiating synchronized transmissions of portions of distributed MIMO communications by a plurality of access points of the wireless network. In a block 1020, the method 1000 further comprises transmitting the message to the plurality of access points. In some aspects, for each access point of the plurality of access points, the message indicates a time for the first wireless device to perform a back-off procedure. In certain such aspects, the message indicates a value of a back-off counter for use by the first wireless device in the back-off procedure.

### Terminology

In the above description, reference numbers may have been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

As used herein, a phrase referring to “at least one of a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor or any commercially available processor, controller, microcontroller or state machine. A processor may also be implemented as a combination of computing devices (e.g., a combination of a DSP and a microprocessor, a plurality of microprocessors, one or more microprocessors in conjunction with a DSP core, or any other such configuration).

In one or more aspects, the functions described may be implemented in hardware, software, firmware, or any combination thereof. If implemented in software, the functions may be stored on or transmitted over as one or more instructions or code on a computer-readable medium.

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

For example, the functions described herein may comprise, in a non-limiting example, a non-transitory computer-readable medium comprising instructions that, when executed, perform a method of transmitting data on a wireless network. In an aspect, the method may comprise determining, by an access point, a plurality of opportunities for initiating synchronized transmissions of portions of distributed MIMO communications by a plurality of access points of the wireless network. The method may further comprise initiating, by the first wireless device, a transmission of a portion of a distributed MIMO communication at an opportunity of the plurality of opportunities.

Continuing this example, the method may further comprise receiving, by the first wireless device, a signal indicative of the plurality of opportunities. The signal may be a beacon signal, a backhaul signal, etc., as described above. The signal may comprise a beacon frame. Determining the plurality of opportunities may be based on the signal. For example, a beacon frame may be received by the first wireless device from a second access point. The method may further comprise decoding the signal to determine a target opportunity time indicated in the signal. The method may further comprise determining that the plurality of opportunities may be based on the target opportunity time.

As another example, the method may further comprise performing a back-off procedure before the opportunity and initiating the transmission in response to successful completion of the back-off procedure before the opportunity. In this case, the method may further comprise transmitting dummy data in response to the successful completion of the back-off procedure, the dummy data transmitted for a time between the successful completion of the back-off procedure and an arbitration interframe space (AIFS) before the opportunity. Furthermore, the method may further comprise initiating the transmission in response to the successful completion of the back-off procedure occurring at least an arbitration interframe (AIFS) space before the opportunity. The method may further comprise receiving, by the first wireless device, a network message indicating a back-off counter value, wherein performing the back-off procedure is based on the received back-off counter value. The method may further comprise receiving, by the first wireless device, a network message indicating a back-off start time, wherein performing the back-off procedure comprises initiating the back-off procedure at the indicated back-off start time.

As another example, the method may further comprise using the first wireless device at the opportunity of the plurality of opportunities to check whether a carrier sense (CS) state of the first wireless device is busy and using the first wireless device to transmit data in response, at least in part, to the CS state being not busy. In an aspect, the first wireless device may not transmit data in response, at least in part, to the CS state being busy. The plurality of opportunities may be determined per access category. The plurality of opportunities may be periodic. The plurality of opportunities may not be periodic. The plurality of opportunities may comprise two or more opportunities within a transmission opportunity (TXOP).

The method may further comprise initiating a first opportunity of the two or more opportunities in response to a successful completion of a back-off procedure before the first opportunity of the two or more opportunities. The method may further comprise initiating a second opportunity of the two or more opportunities without performing an additional back-off procedure. The method may further comprise fragmenting the transmission into at least two separate transmissions, a first transmission occurring from a beginning of a first opportunity of the two or more opportunities to an end time before a second opportunity of the two or more opportunities, and a second transmission occurring from a beginning of the second opportunity. In an aspect, the end time may be at least a PCF Interframe Space (PIFS) before the beginning of the second opportunity. Furthermore, the method may further comprise determining whether a wireless medium of the first wireless device is idle for an arbitration interframe (AIFS) space before the opportunity, wherein initiating the transmission is in response to the wireless medium being idle.

The functions described herein may also comprise, in another non-limiting example, a non-transitory computer-readable medium comprising instructions that, when executed, perform a method of coordinating a distributed MIMO communication of a wireless network. In an aspect, the method may comprise generating a message indicating a plurality of opportunities for initiating synchronized transmissions of portions of distributed MIMO communications by a plurality of access points of the wireless network and transmitting the message to the plurality of access points. In an aspect, for each access point of the plurality of access points, the message may indicate a time for the first wireless device to perform a back-off procedure. In another aspect, the message may indicate a value of a back-off counter for use by the first wireless device in the back-off procedure.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method of coordinating a distributed multiple-input and multiple-output (MIMO) communication of a wireless network, the method comprising:
determining, by a first wireless device of a plurality of wireless devices of the wireless network, a plurality of opportunities for initiating synchronized transmissions, by the plurality of wireless devices, of portions of the distributed MIMO communication; and
initiating, by the first wireless device, at an opportunity of the plurality of opportunities, a transmission of a first portion of the portions of the distributed MIMO communication.

2. The method of claim 1, wherein the first wireless device is a first access point, and wherein the plurality of wireless devices are a plurality of access points.

3. The method of claim 1, the method further comprising receiving, at the first wireless device and from a second wireless device of the plurality of wireless devices, a backhaul signal that is indicative of the plurality of opportunities.

4. The method of claim 1, the method further comprising:
receiving, at the first wireless device and from a second wireless device of the plurality of wireless devices, a frame indicative of the plurality of opportunities; and
decoding the frame to determine that the plurality of opportunities is based on a target opportunity time included in the frame.

5. The method of claim 1, the method further comprising:
performing a back-off procedure before the opportunity of the plurality of opportunities; and
in response to successful completion of the back-off procedure, and before the opportunity, initiating the transmission of the first portion of the portions of the distributed MIMO communication.

6. The method of claim 5, the method further comprising one or more of:
in response to successful completion of the back-off procedure, and for a time between the successful completion and an arbitration interframe space (AIFS) before the opportunity, transmitting dummy data;
in response to successful completion of the back-off procedure, and for a time between the successful completion and an arbitration interframe space (AIFS) before the opportunity, initiating the transmission of the first portion of the portions of the distributed MIMO communication;
receiving, at the first wireless device, an indication of a back-off counter value for performing the back-off procedure; and
receiving, at the first wireless device, an indication of a back-off start time for initiating the back-off procedure at the back-off start time.

7. The method of claim 1, the method further comprising:
determining, by the first wireless device at the opportunity of the plurality of opportunities, whether a carrier sense (CS) state for the first wireless device is busy or not busy; and
in response to determining that the CS state for the first wireless device is not busy, transmitting a first data from the first wireless device, or in response to determining that the CS state for the first wireless device is busy, not transmitting the first data from the first wireless device.

8. The method of claim 1, wherein the plurality of opportunities are determined per access category, and wherein the plurality of opportunities are periodic or the plurality of opportunities are not periodic.

9. The method of claim 1, wherein the plurality of opportunities comprises two or more opportunities within a transmission opportunity (TXOP), and the method further comprises initiating a first opportunity of the two or more opportunities in response to a successful completion of a back-off procedure that occurs before the first opportunity of the two or more opportunities.

10. The method of claim 9, the method further comprising:
initiating a second opportunity of the two or more opportunities without performing a second back-off procedure; and
fragmenting the transmission into at least a first transmission and a second transmission.

11. The method of claim 10, wherein the first transmission starts at a beginning of the first opportunity and ends at least a PCF Interframe Space (PIFS) before the second opportunity, and wherein the second transmission starts at a beginning of the second opportunity.

12. The method of claim 1, the method further comprising:
determining whether a wireless medium is idle for an arbitration interframe (AIFS) space before the opportunity of the plurality of opportunities; and
in response to determining that the wireless medium is idle, initiating the transmission of the first portion of the portions of the distributed MIMO communication.

13. A method of coordinating a distributed multiple-input and multiple-output (MIMO) communication of a wireless network, the method comprising:
generating a message indicating a plurality of opportunities for initiating synchronized transmissions, by a plurality of wireless devices of the wireless network, of portions of the distributed MIMO communication; and
transmitting, from a first wireless device, the message to each of the plurality of wireless devices.

14. The method of claim 13, further comprising generating the message to indicate, for each of the plurality of wireless devices, a time for the first wireless device to perform a back-off procedure.

15. The method of claim 14, further comprising generating the message to indicate a value of a back-off counter for use by the first wireless device during the back-off procedure.

16. An apparatus for coordinating a distributed multiple-input and multiple-output (MIMO) communication of a wireless network, the apparatus comprising:
an electronic hardware processor configured to transmit data on the wireless network,
wherein the apparatus is a first wireless device of a plurality of wireless devices of the wireless network, and wherein the electronic hardware processor is configured to cause the apparatus to:
determine a plurality of opportunities for initiating synchronized transmissions, by the plurality of wireless devices, of portions of the distributed MIMO communication; and
initiate, at an opportunity of the plurality of opportunities, a transmission of a first portion of the portions of the distributed MIMO communication.

17. The apparatus of claim 16, wherein the apparatus is a first access point, and wherein the plurality of wireless devices are a plurality of access points.

18. The apparatus of claim 16, wherein the electronic hardware processor is further configured to cause the apparatus to receive, at the apparatus and from a second wireless device of the plurality of wireless devices, a backhaul signal that is indicative of the plurality of opportunities.

19. The apparatus of claim 16, wherein the electronic hardware processor is further configured to cause the apparatus to:
receive, at the apparatus and from a second wireless device of the plurality of wireless devices, a frame indicative of the plurality of opportunities; and
decode the frame to determine that the plurality of opportunities is based on a target opportunity time included in the frame.

20. The apparatus of claim 16, wherein the electronic hardware processor is further configured to cause the apparatus to:
perform a back-off procedure before the opportunity of the plurality of opportunities; and
in response to successful completion of the back-off procedure, and before the opportunity, initiate the transmission of the first portion of the portions of the distributed MIMO communication.

21. The apparatus of claim 20, wherein the electronic hardware processor is further configured to cause the apparatus to perform one or more of:
in response to successful completion of the back-off procedure, and for a time between the successful completion and an arbitration interframe space (AIFS) before the opportunity, transmit dummy data;
in response to successful completion of the back-off procedure, and for a time between the successful completion and an arbitration interframe space (AIFS) before the opportunity, initiate the transmission of the first portion of the portions of the distributed MIMO communication;
receive, at the apparatus, an indication of a back-off counter value for performing the back-off procedure; and
receive, at the apparatus, an indication of a back-off start time for initiating the back-off procedure at the back-off start time.

22. The apparatus of claim 16, wherein the electronic hardware processor is further configured to cause the apparatus to:
determine, by the apparatus at the opportunity of the plurality of opportunities, whether a carrier sense (CS) state for the apparatus is busy or not busy; and
in response to determining that the CS state for the apparatus is not busy, transmit a first data from the apparatus, or in response to determining that the CS state for the apparatus is busy, not transmit the first data from the apparatus.

23. The apparatus of claim 16, wherein the plurality of opportunities are determined per access category, and wherein the plurality of opportunities are periodic or the plurality of opportunities are not periodic.

24. The apparatus of claim 16, wherein the plurality of opportunities comprises two or more opportunities within a transmission opportunity (TXOP), and wherein the electronic hardware processor is further configured to cause the apparatus to initiate a first opportunity of the two or more opportunities in response to a successful completion of a back-off procedure that occurs before the first opportunity of the two or more opportunities.

25. The apparatus of claim 24, wherein the electronic hardware processor is further configured to cause the apparatus to:
initiate a second opportunity of the two or more opportunities without performing a second back-off procedure; and
fragment the transmission into at least a first transmission and a second transmission.

26. The apparatus of claim 25, wherein the first transmission starts at a beginning of the first opportunity and ends at least a PCF Interframe Space (PIFS) before the second opportunity, and wherein the second transmission starts at a beginning of the second opportunity.

27. The apparatus of claim 16, wherein the electronic hardware processor is further configured to cause the apparatus to:
determine whether a wireless medium is idle for an arbitration interframe (AIFS) space before the opportunity of the plurality of opportunities; and
in response to determining that the wireless medium is idle, initiate the transmission of the first portion of the portions of the distributed MIMO communication.

28. An apparatus for coordinating a distributed multiple-input and multiple-output (MIMO) communication of a wireless network, the apparatus comprising:
an electronic hardware processor, wherein the apparatus is a first wireless device of a plurality of wireless devices of the wireless network, and wherein the electronic hardware processor is configured to cause the apparatus to:
generate a message indicating a plurality of opportunities for initiating synchronized transmissions, by a plurality of wireless devices of the wireless network, of portions of the distributed MIMO communication; and
transmit the message to each of the plurality of wireless devices.

29. The apparatus of claim 28, wherein the electronic hardware processor is further configured to cause the apparatus to generate the message to indicate, for each of the plurality of wireless devices, a time for the apparatus to perform a back-off procedure.

30. The apparatus of claim 29, wherein the electronic hardware processor is further configured to cause the apparatus to generate the message to indicate a value of a back-off counter for use by the apparatus during the back-off procedure.
